(19) United States
(12) Patent Application Publication
(10) Pub. No.: US 2005/0052571 A1
(43) Pub. Date: Mar. 10, 2005

(54) System and method for sending low rate data on a packet basis in an 8-VSB standard data packet stream

(75) Inventor: Monisha Ghosh, Chappaqua, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 09/781,486

(22) Filed: Feb. 12, 2001

(51) Int. Cl. H04N 7/12

(52) U.S. Cl. 348/426.1; 375/265; 375/270

(57) ABSTRACT

There is disclosed a system and method for sending low rate data on a packet basis in an 8-VSB standard data packet stream. The system of the invention comprises an 8-VSB signal transmitter that is capable of transmitting either standard full rate data packets or low rate data packets. A low rate data packet contains less data than is normally contained in a standard data full rate data packet. Each data byte in a low rate data packet contains information bearing bits and non-information bearing bits. The system is capable of assigning appropriate bit values to the non-information bearing bits in each data byte of a low rate data packet so that each low rate data packet will be properly encoded for transmission within an 8-VSB standard data packet stream. High definition television signals composed of low rate data packets possess increased resistance to noise and multipath channels.

### TECHNICAL FIELD OF THE INVENTION

The present invention is generally directed to systems and methods for encoding and decoding digital high definition television signals, and, in particular, to a system and method for transmitting and receiving low rate data on a packet basis in an 8-VSB standard data packet stream.

### BACKGROUND OF THE INVENTION

The Digital High Definition Television (HDTV) Grand Alliance (Grand Alliance) is a group of television manufacturing and research organizations in the television industry. After years of cooperative effort the Grand Alliance developed and proposed a standard for digital HDTV systems. The Grand Alliance standard has been adopted (with a few changes) by the Federal Communication Commission (FCC) as an official broadcasting standard for HDTV. The standard is known as the Advanced Television Systems Committee Digital Television Standard (the “ATSC Standard”).

The ATSC Standard uses an HDTV signal that is modulated as an eight (8) level vestigial sideband (VSB) symbol stream. The ATSC Standard calls for two (2) bit data symbols of the HDTV signal to be trellis encoded in accordance with an eight (8) level (i.e., a three (3) bit) one dimensional constellation. One bit of each data symbol is pre-coded, and the other is subjected to a ½ encoding rate which produces two coded bits in accordance with a four (4) state trellis code. For purposes of interleaving, twelve (12) identical trellis encoders and pre-coders operate successively on every twelve successive data symbols. Symbols 0, 12, 24, 36, are encoded as one series. Symbols 1, 13, 25, 37, . . . are encoded as a second series. Symbols 2, 14, 26, 38, . . . are encoded as a third series. This process continues for a total of twelve (12) series. Therefore, the ATSC Standard requires twelve (12) trellis decoders in the HDTV receiver for the twelve (12) series of time division interleaved data symbols in the signal. Each trellis decoder in the HDTV receiver decodes every twelfth (12th) data symbol in the stream of coded data symbols.

Each of the decoders for the four (4) state trellis code operates in accordance with the well known Viterbi decoding algorithm. Each of the decoders comprises a branch metric calculator unit, an add-compare-select unit, and a path-memory unit. See, for example, “Trellis-Coded Modulation With Redundant Signal Set, Part I: Introduction, and Part II: State of the Art,” by G. Ungerboeck, IEEE Communications Magazine, Volume 25, pp. 5-21, February, 1987.

The ATSC Standard specifies that data packets will be transmitted and received at a standard rate of 19.3 million bits per second (19.3 Mbps). The ATSC Standard does not provide for the transmission and reception of data packets at rates lower than 19.3 Mbps.

If data could be transmitted and received at an effective data rate that is lower than standard rate of 19.3 Mbps, it would be possible to transmit and receive a high definition television (HDTV) signal that would possess increased resistance to noise and multipath channels.

There is therefore a need in the art for a system and method that can utilize existing ATSC Standard equipment to transmit and receive low rate data on a packet basis in an 8-VSB standard data packet stream.

### SUMMARY OF THE INVENTION

The present invention generally comprises a system and method for transmitting and receiving low rate data on a packet basis in an 8-VSB standard data packet stream.

In an advantageous embodiment of the present invention, the system of the invention comprises a high definition television (HDTV) transmitter that is capable of transmitting either standard “full rate” data packets or “low rate” data packets. A low rate data packet contains less data than is normally contained in a standard data full rate data packet. Each data byte in a low data rate packet contains information bearing bits and non-information bearing bits. The improved transmitter is capable of assigning appropriate bit values to the non-information bearing bits in each data byte of a low rate data packet so that each low rate data packet will be properly encoded for transmission within the 8-VSB standard data packet stream. The system of the invention also comprises a high definition television (HDTV) receiver that is capable of receiving either standard full rate data packets or low rate data packets.

It is a primary object of the present invention to provide a system and method for transmitting and receiving high definition television signals that possess increased resistance to noise and multipath channels.

It is another object of the present invention to provide a system and method for transmitting and receiving low rate data packets in an 8-VSB standard data packet stream in which the low rate data packets contain less data than is normally contained in a standard full rate data packet.

It is an additional object of the present invention to provide a system and method for transmitting and receiving low rate data packets at an effective data rate that is lower than the standard rate of 19.3 Mbps.

It is another object of the present invention to provide a system and method for transmitting and receiving both low rate data packets and full rate data packets on ATSC Standard equipment.

The foregoing has outlined rather broadly the features and technical advantages of the present invention so that those skilled in the art may better understand the Detailed Description of the Invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an exemplary high definition television (HDTV) transmitter;

FIG. 2 illustrates a block diagram of an exemplary high definition television (HDTV) receiver;

FIG. 3 illustrates a block diagram of a trellis encoder comprising twelve (12) parallel trellis encoder and pre-coder units for twelve groups of interleaved data symbols;

FIG. 4 illustrates a block diagram of one exemplary trellis encoder and pre-coder unit (one of the twelve (12) such units shown in FIG. 3) and an eight (8) level symbol mapper;

FIG. 5 illustrates an exemplary byte in a full rate data packet;

FIG. 6 illustrates an exemplary byte in a low rate data packet in which the exemplary byte contains half the data that is contained in a byte in a full rate data packet;

FIG. 7 is illustrates a block diagram of an advantageous embodiment of the system of the present invention;

FIG. 8 illustrates a block diagram of an advantageous embodiment of a portion of a high definition television (HDTV) receiver operating in accordance with the principles of the present invention; and

FIG. 9 illustrates a flow diagram showing an advantageous embodiment of the method of the present invention.

### DETAILED DESCRIPTION OF THE INVENTION

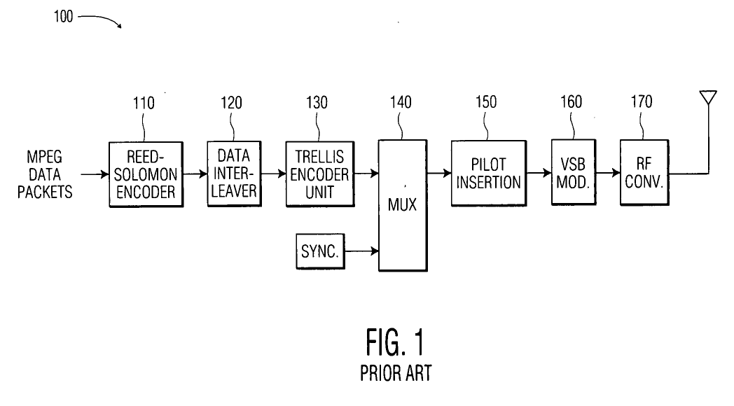

FIGS. 1 through 9, discussed below, and the various embodiments set forth in this patent document to describe the principles of the improved system and method of the present invention are by way of illustration only and should not be construed in any way to limit the scope of the invention. Those skilled in the art will readily understand that the principles of the present invention may also be successfully applied in any type of device for evaluating video quality.

FIG. 1 illustrates a block diagram of an exemplary high definition television (HDTV) transmitter 100. MPEG compatible data packets are encoded for forward error correction (FEC) by a Reed Solomon (RS) encoder 110. The data packets in successive segments of each data field are then interleaved by data interleaver 120, and the interleaved data packets are then further interleaved and encoded by trellis encoder unit 130. Trellis encoder unit 130 produces a stream of data symbols having three (3) bits each. One of the three bits is pre-coded and the other two bits are produced by a four (4) state trellis encoding.

As will be more fully discussed, trellis encoder unit 130 comprises twelve (12) parallel trellis encoder and pre-coder units to provide twelve interleaved coded data sequences. The encoded three (3) bits of each trellis encoder and pre-coder unit are combined with field and segment synchronization bit sequences in multiplexer 140. A pilot signal is then inserted by pilot insertion unit 150. The data stream is then subjected to vestigial sideband (VSB) suppressed carrier eight (8) level modulation by VSB modulator 160. The data stream is then finally up-converted to a radio frequency by radio frequency (RF) converter 170. The abbreviation NTSC stands for National Television Standards Committee.

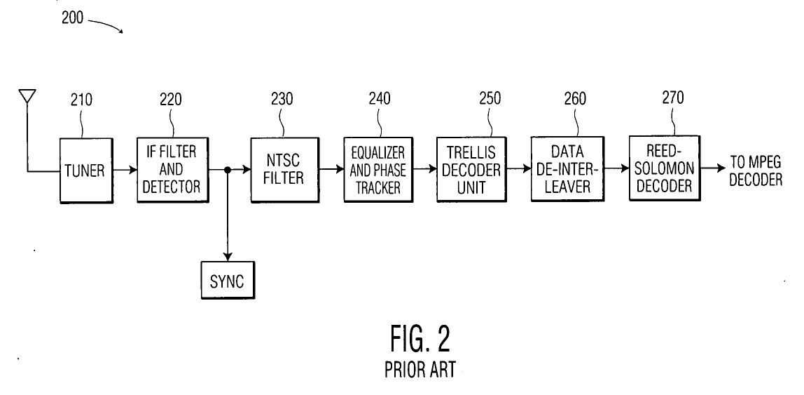

FIG. 2 illustrates a block diagram of an exemplary high definition television (HDTV) receiver 200. The received RF signal is down-converted to an intermediate frequency (IF) by tuner 210. The signal is then filtered and converted to digital form by IF filter and detector 220. The detected signal is then in the form of a stream of data symbols that each signify a level in an eight (8) level constellation. The signal is then filtered by NTSC rejection filter 230 and subjected to equalization and phase tracking by equalizer and phase tracker 240. The recovered encoded data symbols are then subjected to trellis decoding by trellis decoder unit 250. The decoded data symbols are then further de-interleaved by data de-interleaver 260. The data symbols are then subjected to Reed Solomon decoding by Reed Solomon decoder 270. This recovers the MPEG compatible data packets transmitted by transmitter 100.

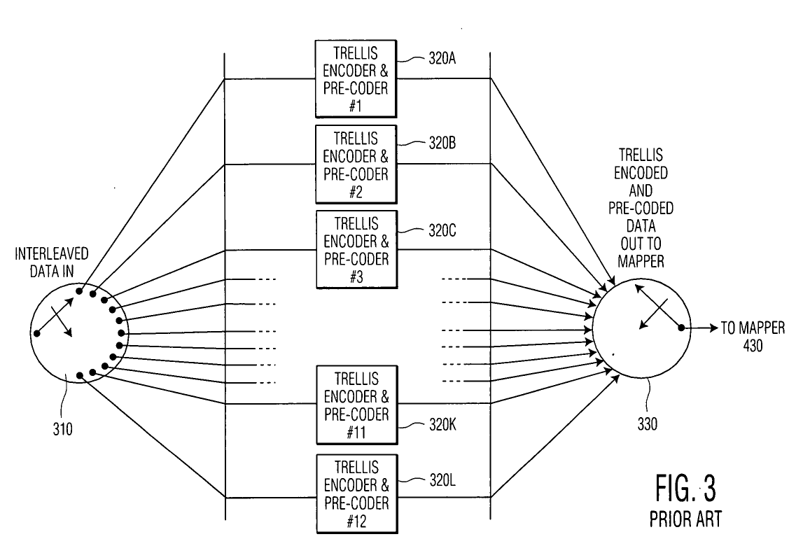

FIG. 3 illustrates how the interleaved data from data interleaver 120 are further interleaved during the trellis encoding process. Demultiplexer 310 of trellis encoder unit 130 distributes each successive series of twelve (12) data symbols among twelve (12) successive trellis encoder and pre-coder units, 320A, 320B, . . . , 320K, and 320L. The encoded outputs of the twelve (12) successive trellis encoder and pre-coder units are then time division multiplexed by multiplexer 330 to form a single data stream. The single data stream is sent to eight (8) level symbol mapper 430 of trellis encoder unit 130.

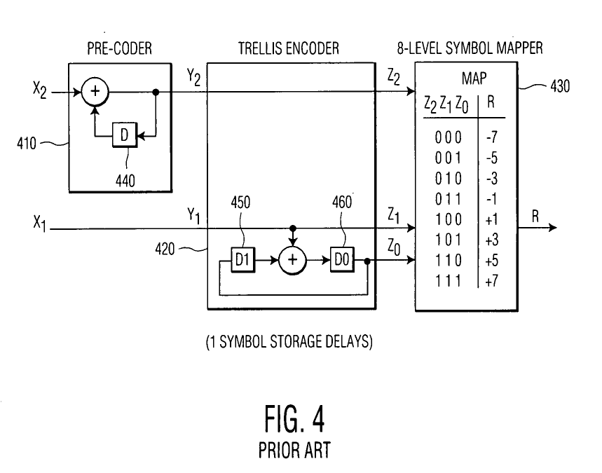

FIG. 4 illustrates a block diagram of an exemplary trellis encoder and pre-coder unit 320A and its output to eight (8) level symbol mapper 430. Not shown in FIG. 4 is multiplexer 330 that couples trellis encoder and pre-coder unit 320A to eight (8) level symbol mapper 430. Trellis encoder and pre-coder unit 320A comprises pre-coder 410 and trellis encoder 420. Each data symbol to be encoded comprises two bits, X₁ and X₂. Bit X₂ is pre-coded by pre-coder 410 which comprises a one bit register 440 to derive pre-coded bit Y₂. Bit Y₂ is not altered further by trellis encoder 420 and is output as bit Z₂.

The other input bit, X₁, does not pass through pre-coder 410. Bit X₁ (also denoted bit Y₁) does pass through trellis encoder 420. Trellis encoder 420 encodes bit X₁ in accordance with a ½ trellis code utilizing one bit data registers, 450 and 460. The result is output as bit Z₀ and bit Z₁. Therefore, three bits (i.e., bit Z₀, bit Z₁, and bit Z₂) are output by trellis encoder 420 to eight (8) level symbol mapper 430. Eight (8) level symbol mapper 430 converts the three bits to a value R in an eight (8) level constellation of permissible code values. The permissible code values for R are −7, −5, −3, −1, +1, +3, +5, and +7. These values correspond with the three bit combinations shown in eight (8) level symbol mapper 430.

The above described process is carried out for each of the twelve interleaved series of data symbols. Eight (8) level symbol mapper 430 comprises a look-up table for selecting the correct R code value for a given set of three input bits. It is seen that the eight (8) level constellation has four possible subsets of bits Z₀ and Z₁, each subset having dual possible constellation values depending upon whether the pre-coded bit Z₂ is a zero (“0”) or a one (“1”). For a basic description of the logic operations involved in trellis encoding and decoding, refer to “Principles of Communication Systems,” by H. Taub et al., McGraw Hill Book Company, pp. 562-571, 1986.

The ATSC Standard specifies that data packets will be transmitted and received at a standard rate of 19.3 million bits per second (19.3 Mbps). The ATSC Standard does not provide for the transmission and reception of data packets at rate lower than 19.3 Mbps. In the ATSC Standard each data byte contains eight (8) bits of data. The present invention provides a system and a method for transmitting data at an effective data rate that is lower than standard rate of 19.3 Mbps. The present invention accomplishes this by transmitting and receiving data packets that contain data bytes that contain fewer than eight (8) bits of data in each data byte.

Data packets that contain data bytes that contain fewer than eight (8) bits of data in each data byte are referred to as “low rate” data packets. Data packets that contain data bytes that contain eight (8) bits of data in each data byte are referred to as “full rate” data packets.

In particular, the present invention will be described as a system and method for transmitting and receiving data packets that contain one half of the data that is normally contained in a standard “full rate” data packet. These data packets are referred to as “half rate” data packets. It is understood that the “half rate” data packets represent only one advantageous embodiment of the present invention. Other “low rate” data packets (i.e., other than “half rate” data packets) may also be used in accordance with the principles of the present invention.

As will be more fully explained, the half rate data packets of the present invention are encoded with a different symbol set (i.e., a four (4) level symbol set) in such a way that the resulting symbol stream can be correctly received and decoded by existing ATSC Standard receivers. The half rate data packets of the present invention are encoded in such a way that the presence of the half rate data packets in the symbol stream will not adversely affect the performance of existing ATSC Standard receivers in the decoding of full rate data packets. That is, existing ATSC Standard receivers will be able to receive both full rate data packets and half rate data packets. The Reed Solomon decoder in an existing ATSC Standard receiver will not flag the half rate data packets as “error” packets. However, the MPEG decoder that follows the Reed Solomon decoder in an existing ATSC Standard receiver will not be able to correctly decode the half rate data packets. In order to be able to correctly decode the half rate data packets, an existing ATSC Standard receiver must be modified in a manner that will be described below.

According to the ATSC Standard, a data packet comprises one hundred eighty seven (187) bytes. There are eight (8) bits in each byte. FIG. 5 illustrates an exemplary byte 500 in a full rate data packet. The eight (8) bits in byte 500 are numbered from 0 to 7. In a full rate data packet, all eight (8) bits in byte 500 are payload“data bits. That is, each of the eight (8) bits in byte 500 carries one bit of data. Reed Solomon encoder 110 encodes the 187 bytes in a full rate data packet according to a generator polynomial specified by the ATSC Standard. Reed Solomon encoder 110 then appends twenty (20) parity bytes to form a codeword of two hundred seven (207) bytes. This type of code is referred to as a systematic code because the data bytes are unchanged in the encoded codeword.

According to the ATSC standard, the Reed Solomon encoder 110 sends the 207 byte codewords to data interleaver 120. Data interleaver 120 processes the 207 byte codewords and sends them to trellis encoder 130. In trellis encoder 130, bits 7,5,3,1 of each byte are pre-coded and bits 6,4,2,0 of each byte are trellis encoded. The three (3) bits at the output of trellis encoder 130 are mapped into one of the eight (8) R values by eight (8) level symbol mapper 430. This is the standard method for full rate data packets.

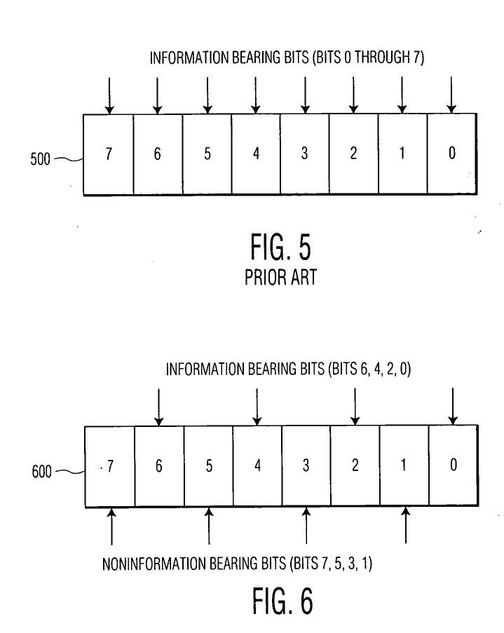

FIG. 6 illustrates an exemplary byte 600 in a half rate data packet of the present invention. The eight (8) bits in byte 600 are numbered from 0 to 7 in the same manner as the bits in byte 500. In a half rate data packet, four (4) bits in byte 600 are “payload” data bits. A “payload” bit carries one bit of data. In an advantageous embodiment of the present invention, the “payload” bits are bits 6,4,2,0. That is, bits 6,4,2,0 are information bearing bits. The other four (4) bits in byte 600 may have any value. In this advantageous embodiment of the present invention, bits 7,5,3,1 may have any value. That is, bits 7,5,3,1 are non-information bearing bits.

When a data stream is processed in transmitter 100, data is encoded in Reed Solomon encoder 110. Then the resulting data bytes are interleaved in data interleaver 120 and encoded in trellis encoder 130. In order to ensure that the encoding process correctly encodes half rate data packets, it is necessary to know what value each of the non-information bearing bits should have. As will be more fully described, the system and method of the present invention obtains the correct values for the non-information bearing bits.

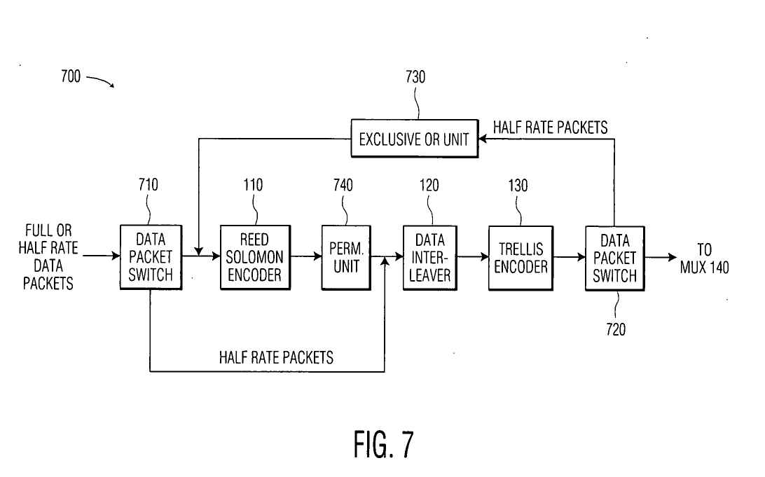

FIG. 7 illustrates a block diagram of an advantageous embodiment of the system 700 of the present invention. As shown in FIG. 7, the system receives either full rate data packets or half rate data packets in data packet switch 710. Data packet switch 710 reads information from an incoming data packet to determine whether the data packet is a full rate data packet or a half rate data packet. At least one bit (referred to as a “rate” bit) in a field sync segment is capable of identifying whether the data packet is to be treated as a full rate data packet or is to be treated as a half rate data packet. For example, if the “rate” bit is set equal to “zero,” then the data packet is treated as a full rate data packet. If the “rate” bit is set equal to “one,” then the data packet is treated as a half rate data packet. A plurality of bits in a field sync segment can identify which data packets in a segment are full rate data packets and which are half rate data packets. A full rate data packet and a half rate data packet have the same length and the same number of bytes. The difference is that only half of the bits in a half rate data packet are information carrying bits.

Data packet switch 710 sends the full rate data packets directly to Reed Solomon encoder 110. Data packet switch 710 sends the half rate data packets directly to data interleaver 120, bypassing Reed Solomon encoder 110. Data interleaver 120 processes the 207 byte codewords and sends them to trellis encoder 130. In trellis encoder 130, bits 7,5,3,1 of each byte are pre-coded and bits 6,4,2,0 of each byte are trellis encoded. The three (3) bits at the output of trellis encoder 130 are mapped into one of the eight (8) R values by eight (8) level symbol mapper 430.

At this stage, the values for the information bearing bits (i.e., bits 6,4,2,0) are known. The task is to find the values of the non-information bearing bits (i.e., bits 7,5,3,1) so that each output symbol is from one of four (4) levels. From FIG. 4 it is seen that if the value Z₂ is set equal to Z₀, then each output symbol will be from the set −7, −3, +3 and +7. The correct value for each of the non-information bearing bits, X₂(k), can then be obtained from the expression:
X₂(k)=Z₂(k)⊕Z₂ (k−12) (1)
where k is a time index and where the operator ⊕ signifies the logical operation of “exclusive OR.”

The output of trellis encoder 130 is sent to data packet switch 720. Data packet switch 720 reads the “rate” bit in the field sync segment to determine whether the data packet is a full rate data packet or a half rate data packet. If the data packet is a full rate data packet, data packet switch 720 sends the full rate data packet directly to multiplexer 140. If the data packet is a half rate data packet, then data packet switch 720 sends the half rate data packet to exclusive OR unit 730. Exclusive OR unit 730 performs the exclusive OR operation described in Equation (1) to obtain the values X₂(k) of the non-information bearing bits (7,3,2,1) of each byte in the half rate data packet.

The complete set of eight (8) bits for each data byte (i.e., bits 7,6,5,4,3,2,1,0) for the half rate packet is then fed back to Reed Solomon encoder 110 to generate the appropriate parity bytes for the half rate data packet. Because the Reed Solomon encoder 110 is reset after every data frame, each one of the three hundred twelve (312) Reed Solomon codewords in a data frame has a set of predetermined positions for data symbols and parity symbols. This set of predetermined positions ensures that after the data passes through data interleaver 120, the parity symbols of each codeword come after the data symbols in that codeword. The Reed Solomon encoder 110 places the parity bytes into the appropriate predetermined positions for the half rate packet.

The half rate packet is then sent to permutation unit 740. When permutation unit 740 receives a data packet, permutation unit 740 reads the “rate” bit in the field sync segment to determine whether the data packet is a full rate data packet or a half rate data packet. If the data packet is a full rate data packet, permutation unit 740 sends the full rate data packet directly to data interleaver 120 and does not permute (i.e., rearrange) the bytes in the full rate data packet. If the data packet is a half rate data packet, then permutation unit 740 permutes the bytes in the half rate data packet using a permutation algorithm.

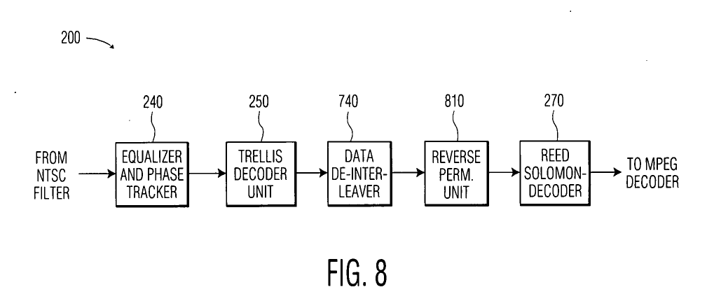

Permutation unit 740 permutes the bytes in the half rate data packet to ensure that parity byte positions do not occur before the data byte positions in each data packet. Permuting the bytes in the data packet creates a new data packet that can be decoded by Reed Solomon decoder 270 in receiver 200. The decoded data from the new (permuted) data packet will give results that are different from the original data packet. However, if the permutation algorithm in permutation unit 740 is provided to a reverse permutation unit 810 located before Reed Solomon decoder 270 in receiver 200 (shown in FIG. 8), then reverse permutation unit 810 can reverse the permutation so that Reed Solomon decoder 270 can correctly recover the data packet. This will enable receiver 200 to correctly read the data in the half rate packets.

After permutation unit 740 permutes the bytes in a half rate data packet, then permutation unit 740 changes the “rate” bit in the field sync segment from the value “one” (indicating a half rate data packet) to the value “zero” (indicating a full rate data packet). Permutation unit 740 then sends the data packet to data interleaver 120. Permutation unit 740 changes the status of the data packet from “half rate” to “full rate” so that when the data packet reaches data packet switch 720 the data packet will be correctly sent to multiplexer 140 and not incorrectly sent to exclusive OR unit 730.

The system and method of the present invention is capable of handling both full rate data packets and half rate data packets. When a full rate data packet enters data packet switch 710, the full rata data packet passes through data packet switch 710 to Reed Solomon decoder 110. The full rate data packet then passes through permutation unit 740 without being permuted. The full rate data packet then passes through data interleaver 120 and trellis encoder 130 to data packet switch 720. The full rate data packet then passes through data packet switch 720 to multiplexer 140.

When a half rate data packet enters data packet switch 710, the half rate data packet is sent directly to data interleaver 120. The half rate data packet passes through data interleaver 120 and trellis encoder 130 to data packet switch 720. The half rate data packet is then sent to exclusive OR unit 730. The half rate data packet is then sent to Reed Solomon decoder 110 and permutation unit 740. Permutation unit 740 permutes the bytes in half rate data packet and changes the “rate” status bit of the half rate data packet from “half rate” status to “full rate” status. The permuted half rate data packet is then sent to data interleaver 120 and trellis encoder 130. The permuted half rate data packet is then sent to data packet switch 720. Because data packet switch 720 identifies the permuted half rate data packet as a full rate data packet, data packet switch 720 sends the permuted half rate data packet to multiplexer 140 and the rest of transmitter 100.

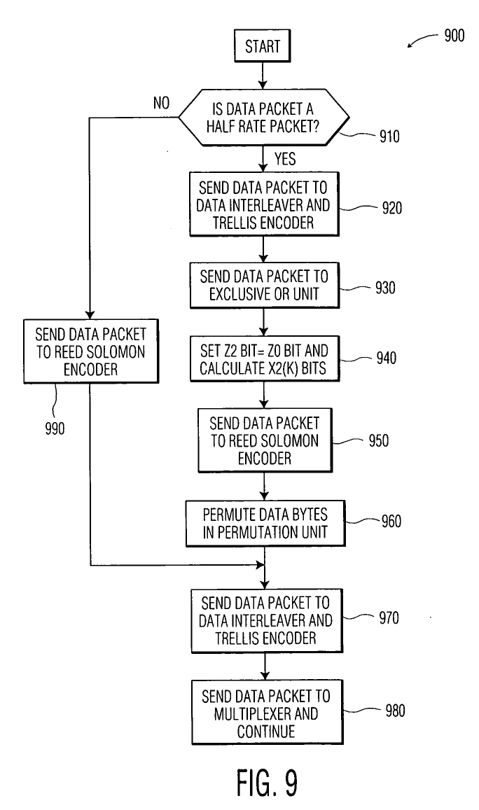

FIG. 9 is a flow diagram illustrating the improved method of the present invention. The steps of the improved method are collectively referred to with reference number 900. In the first step a determination is made whether a data packet is a half rate data packet or a full rate data packet (decision step 910). If the if data packet is a half rate data packet, then the data packet is sent directly to data interleaver 120 and then to trellis encoder 130 (step 920). The half rate data packet is then sent to exclusive OR unit 730 (step 930). Exclusive OR unit 730 sets the Z₂ bit equal to the Z₀ bit and calculates the X₂(k) bits(step 940).

Then the half rate data packet is sent to Reed Solomon encoder 110 (step 950). The half rate data packet is then sent to permutation unit 740 which permutes the data bytes in the half rate data packet (step 960). As previously described, permutation unit 740 changes the status of the half rate data packet to the status of a full rate data packet. The data packet is now sent to data interleaver 120 and then to trellis encoder 130 (step 920). The data packet is then sent to multiplexer 140 (step 980) and the process continues.

If the if data packet at decision step 910 is a full rate data packet, then the data packet is sent to Reed Solomon encoder 110 (step 990). The data packet is then sent to data interleaver 120 and then to trellis encoder 130 (step 970). The data packet is then sent to multiplexer 140 (step 980) and the process continues.

Although the present invention has been described in detail, those skilled in the art should understand that they can make various changes, substitutions and alterations herein without departing from the spirit and scope of the invention in its broadest form.

1. A system for sending low rate data on a packet basis in an 8-VSB standard data packet stream, said system comprising:
an 8-VSB signal transmitter capable of transmitting a low rate data packet that comprises data bytes that contain both information bearing bits and non-information bearing bits.

2. The system for sending low rate data on a packet basis in an 8-VSB standard data packet stream as claimed in claim 1 wherein said 8-VSB signal transmitter is capable of determining the values of said non-information bearing bits in said low rate data packet so that said non-information bearing bits will be correctly encoded.

3. The system for sending low rate data on a packet basis in an 8-VSB standard data packet stream as claimed in claim 1 wherein said low rate data packet comprises data bytes in which half of the bits in each data byte contain information and half of the bits in each data byte do not contain information.

4. The system for sending low rate data on a packet basis in an 8-VSB standard data packet stream as claimed in claim 3 wherein said 8-VSB signal transmitter is capable of determining the values of said bits that do not contain information so that said bits that do not contain information will be correctly encoded.

5. The system for sending low rate data on a packet basis in an 8-VSB standard data packet stream as claimed in claim 3 wherein said low rate data packet comprises eight (8) bit data bytes in which bit 6, bit 4, bit 2, and bit 0 in each data byte contain information and in which bit 7, bit 5, bit 3, and bit 1 in each data byte do not contain information.

6. The system for sending low rate data on a packet basis in an 8-VSB standard data packet stream as claimed in claim 5 wherein said 8-VSB signal transmitter is capable of determining the values of bit 7, bit 5, bit 3, and bit 1 so that they will be correctly encoded.

7. The system for sending low rate data on a packet basis in an 8-VSB standard data packet stream as claimed in claim 6 wherein said 8-VSB signal transmitter determines the values of bit 7, bit 5, bit 3, and bit 1 so that each output symbol is from one of the four levels −7, −3, +3, and +7 by setting the value of the Z₂ bit from a trellis encoder of said 8-VSB signal transmitter equal to the value of the Z₀ bit from said trellis encoder.

8. The system for sending low rate data on a packet basis in an 8-VSB standard data packet stream as claimed in claim 7 wherein said 8-VSB signal transmitter determines the values of bit 7, bit 5, bit 3, and bit 1 by calculating the values of bit 7, bit 5, bit 3, and bit 1 from the expression:
X₂(k)=Z₂(k)⊕Z₂(k−12)
where X₂(k) represents the value of a bit before the bit is input to a pre-coder of said trellis encoder, and where Z₂ represents the value of a bit after the bit is output from said trellis encoder, and where k is a time index, and where the operator ⊕ signifies a logical exclusive OR operation.

9. A system for sending half rate data on a packet basis in an 8-VSB standard data packet stream in an 8-VSB signal transmitter of the type comprising a Reed Solomon encoder, a data interleaver, and a trellis encoder, wherein said system comprises:
a first data packet switch before said Reed Solomon encoder capable of determining whether a data packet is a full rate data packet or a half rate data packet, said first data packet switch capable of sending a full rate data packet to said Reed Solomon decoder and capable of sending a half rate data packet to said data interleaver; and
a second data packet switch after said trellis encoder capable of determining whether a data packet is a full rate data packet or a half rate data packet, said second data packet switch capable of sending a full rate data packet to a multiplexer and capable of sending a half rate data packet to an exclusive OR unit.

10. The system for sending half rate data on a packet basis in an 8-VSB standard data packet stream as claimed in claim 9 wherein said exclusive OR unit is capable of determining the values of bits in a half rate data packet that do not contain information so that said bits that do not contain information will be correctly encoded.

11. The system for sending half rate data on a packet basis in an 8-VSB standard data packet stream as claimed in claim 10 wherein said half rate data packet comprises eight (8) bit data bytes in which bit 6, bit 4, bit 2, and bit 0 in each data byte contain information and in which bit 7, bit 5, bit 3, and bit 1 in each data byte do not contain information; and
wherein said exclusive OR unit is capable of determining the values of bit 7, bit 5, bit 3, and bit 1 so that each output symbol is from one of the four levels −7, −3, +3, and +7 by setting the value of the Z₂ bit from said trellis encoder equal to the value of the Z₀ bit from said trellis encoder.

12. The system for sending half rate data on a packet basis in an 8-VSB standard data packet stream as claimed in claim 11 wherein said exclusive OR unit is capable of determining the values of bit 7, bit 5, bit 3, and bit 1 by calculating the values of bit 7, bit 5, bit 3, and bit 1 from the expression:
X₂(k)=Z₂(k)⊕Z₂(k−12)
where X₂(k) represents the value of a bit before the bit is input to a pre-coder of said trellis encoder, and where Z₂ represents the value of a bit after the bit is output from said trellis encoder, and where k is a time index, and where the operator ⊕ signifies a logical exclusive OR operation.

13. The system for sending half rate data on a packet basis in an 8-VSB standard data packet stream as claimed in claim 12 wherein an output of said exclusive OR unit is coupled to an input of said Reed Solomon encoder; and wherein said exclusive OR unit is capable of sending a half rate data packet to said Reed Solomon encoder in which the values of bit 7, bit 5, bit 3, and bit 1 in each data byte of said half rate data packet have been determined so that all eight (8) bits in each data byte of said half rate data packet will be correctly encoded.

14. The system for sending half rate data on a packet basis in an 8-VSB standard data packet stream as claimed in claim 13 further comprising:
a permutation unit located after said Reed Solomon encoder and before said data interleaver, said permutation unit capable of determining whether a data packet is a full rate data packet or a half rate data packet, said permutation unit capable of sending a full rate data packet to said data interleaver without performing a permutation, said permutation unit capable of permuting the bytes in a half rate data packet to ensure that parity byte positions do not occur before the data byte positions in each data packet.

15. The system for sending half rate data on a packet basis in an 8-VSB standard data packet stream as claimed in claim 14 wherein said permutation unit is capable of setting a rate bit in a field sync segment of said half rate data packet to change the status of said half rate data packet from half rate status to full rate status.

16. The system for sending half rate data on a packet basis in an 8-VSB standard data packet stream as claimed in claim 15 further comprising an 8-VSB signal receiver comprising:
a reverse permutation unit located between a data de-interleaver and a Reed Solomon decoder, said reverse permutation unit capable of reversing the permutation of bytes carried out by said permutation unit of said 8-VSB signal transmitter.

17. A method for sending low rate data on a packet basis in an 8-VSB standard data packet stream, said method comprising the steps of:
placing data in a low rate data packet that comprises data bytes that contain both information bearing bits and non-information bearing bits;
determining the values of said non-information bearing bits in said low rate data packet so that said non-information bearing bits will be correctly encoded; and
transmitting said low rate data packet with an 8-VSB signal transmitter.

18. The method for sending low rate data on a packet basis in an 8-VSB standard data packet stream as claimed in claim 17 wherein said low rate data packet comprises data bytes in which half of the bits in each data byte contain information and half of the bits in each data byte do not contain information.

19. The method for sending low rate data on a packet basis in an 8-VSB standard data packet stream as claimed in claim 17 wherein the step of placing data in a low rate data packet that comprises data bytes that contain both information bearing bits and non-information bearing bits comprises the steps of:
placing data in bit 6, bit 4, bit 2, and bit 0 in each eight (8) bit data byte so that bit 6, bit 4, bit 2, and bit 0 are information bearing bits; and
placing no data in bit 7, bit 5, bit 3, and bit 1 in each eight (8) bit data byte so that bit 7, bit 5, bit 3, and bit 1 are non-information bearing bits.

20. The method for sending low rate data on a packet basis in an 8-VSB standard data packet stream as claimed in claim 19 wherein the step of determining the values of said non-information bearing bits in said low rate data packet so that said non-information bearing bits will be correctly encoded comprises the step of:
setting the value of the Z₂ bit from a trellis encoder of said 8-VSB signal transmitter equal to the value of the Z₀ bit from said trellis encoder so that each output symbol is from one of four levels −7, −3, +3, and +7; and
calculating the values of bit 7, bit 5, bit 3, and bit 1 from the expression:
X₂(k)=Z₂(k)⊕Z₂(k−12)
where X₂(k) represents the value of a bit before the bit is input to a pre-coder of said trellis encoder, and where Z₂ represents the value of a bit after the bit is output from said trellis encoder, and where k is a time index, and where the operator ⊕ signifies a logical exclusive OR operation.

21. The method for sending low rate data on a packet basis in an 8-VSB standard data packet stream as claimed in claim 20 further comprising the steps of:
permuting the bytes in said low rate data packet to ensure that parity byte positions of said low rate data packet do not occur before the data byte positions in each low rate data packet; and
reverse permuting said permuted bytes in said low rate data packet after said low rate data packets are received in an 8-VSB signal receiver.

22. The method for sending low rate data on a packet basis in an 8-VSB standard data packet stream as claimed in claim 19 further comprising the steps of:
sending said low rate data packet through a data interleaver;
sending said low rate data packet through a trellis encoder;
sending said low rate data packet through an exclusive OR unit;
sending said low rate data packet through a Reed Solomon encoder;
sending said low rate data packet through a permutation unit;
sending said low rate data packet through said data interleaver a second time; and
sending said low rate data packet through said trellis encoder a second time.

23. A high definition television system comprising a system for sending low rate data on a packet basis in an 8-VSB standard data packet stream, said system comprising:
an 8-VSB signal transmitter capable of transmitting a low rate data packet that comprises data bytes that contain both information bearing bits and non-information bearing bits.

24. The high definition television system as claimed in claim 23 wherein said 8-VSB signal transmitter is capable of determining the values of said non-information bearing bits in said low rate data packet so that said non-information bearing bits will be correctly encoded.

25. The high definition television system as claimed in claim 23 wherein said low rate data packet comprises eight (8) bit data bytes in which bit 6, bit 4, bit 2, and bit 0 in each data byte contain information and in which bit 7, bit 5, bit 3, and bit 1 in each data byte do not contain information; and wherein said 8-VSB signal transmitter is capable of determining the values of bit 7, bit 5, bit 3, and bit 1 so that they will be correctly encoded.

26. The high definition television system as claimed in claim 25 wherein said 8-VSB signal transmitter determines the values of bit 7, bit 5, bit 3, and bit 1 so that each output symbol is from one of the four levels −7, −3, +3, and +7 by setting the value of the Z₂ bit from a trellis encoder of said 8-VSB signal transmitter equal to the value of the Z₀ bit from said trellis encoder.

27. The high definition television system as claimed in claim 26 wherein said 8-VSB signal transmitter determines the values of bit 7, bit 5, bit 3, and bit 1 by calculating the values of bit 7, bit 5, bit 3, and bit 1 from the expression:
X₂(k)=Z₂(k)⊕Z₂(k−12)
where X₂(k) represents the value of a bit before the bit is input to a pre-coder of said trellis encoder, and where Z₂ represents the value of a bit after the bit is output from said trellis encoder, and where k is a time index, and where the operator ⊕ signifies a logical exclusive OR operation.

28. The high definition television system as claimed in claim 27 further comprising:
a permutation unit located after a Reed Solomon encoder and before a data interleaver in said 8-VSB signal transmitter, said permutation unit capable of permuting the bytes in a half rate data packet to ensure that parity byte positions do not occur before the data byte positions in each data packet.

29. The high definition television system as claimed in claim 28 further comprising:
an 8-VSB signal receiver comprising a reverse permutation unit located between a data de-interleaver and a Reed Solomon decoder of said 8-VSB signal receiver, said reverse permutation unit capable of reversing the permutation of bytes carried out by said permutation unit of said 8-VSB signal transmitter.
